(19) United States
(12) Patent Application Publication
(10) Pub. No.: US 2014/0130327 A1
(43) Pub. Date: May 15, 2014

(54) Wet/Dry Vacuum Cleaner Leaf Mulcher

(71) Applicant: Emerson Electric Co., St. Louis, MO (US)

(72) Inventor: John L. Theising, St. Peters, MO (US)

(73) Assignee: Emerson Electric Co., St. Louis, MO (US)

(21) Appl. No.: 14/079,624

(22) Filed: Nov. 13, 2013

Related U.S. Application Data
(60) Provisional application No. 61/725,685, filed on Nov. 13, 2012.

(51) Int. Cl. A01G 3/00; A01G 1/12

(52) U.S. Cl. CPC A01G 3/002; A01G 1/125
USPC 29/426.2; 15/246.2; 29/428

(57) ABSTRACT

An attachment for a utility vacuum appliance, having a housing with an inlet and an outlet, the inlet configured to mate with a hose and the outlet configured to mate with a port of a vacuum appliance; and a mulching assembly within the housing and operable to mulch yard debris as the debris passes from the inlet to the outlet. In another embodiment, the attachment comprises a housing with an inlet and an outlet, the inlet configured to mate with a port of a vacuum appliance; and a mulching assembly within the housing and operable to mulch yard debris as the debris passes from the inlet to the outlet.

### CROSS REFERENCE TO RELATED APPLICATIONS

This application claims priority to U.S. Provisional Patent Application Ser. No. 61/725,685, filed Nov. 13, 2012, the contents of which are incorporated herein by reference in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to wet/dry utility vacuum appliances, and more specifically are related to attachments and accessories for use with such vacuum appliances for use in handling yard debris.

2. Description of the Related Art

A variety of appliances are available for use by homeowners and lawncare professionals for the clean-up and removal of yard debris, such as leaves, grass clippings, and small twigs and branches. These appliances may generally be characterized as being of two different types—vacuum-assisted shredding apparatus, and blower/vacuum apparatus. Vacuum-assisted apparatus for use in shredding leaves and other yard debris often include a rotating cutting means and a fan or impeller directly associated with the rotating cutting means. The rotating impeller acts to suck the yard debris into the vacuum housing, toward and through a cutting means located and mounted within the vacuum, thereafter blowing the shredded debris through an outlet into a collection reservoir.

Convertible blower/vacuum units (blower/vacs) are commonly used by homeowners and professionals alike for the removal of debris from yards, driveways, sidewalks, etc. Such convertible blower/vacs are generally portable devices which can be configured for use as either a debris blower or a debris vacuum. When used as a vacuum, vacuum attachments coupled to the blower housing permit leaves or similar debris to be vacuumed into an attached bag or other debris container.

U.S. Pat. No. 6,442,790 to Svoboda, et al. describes a blower/vacuum having an air net cover and a blower tube, both of which attach to a blower housing for operation in a blower mode. The air net cover is preferably able to removably attach to the blower housing and the blower tube. The blower/vacuums described may generally prohibit operation unless both the blower tube and the air inlet cover are first installed. The blower/vacuum is described to be further adapted to operate in a vacuum mode by removing the air net cover and blower tube and replacing the same with a vacuum tube assembly and a vacuum collection container, respectively.

U.S. Pat. No. 4,682,740 discloses a “shredder has a container enclosing a chamber. A shredding mechanism is rotatably mounted in the chamber and is driven by an exteriorly located motor. A loading port is provided in the container through which the material to be shredded may be received in the chamber. The arrangement of the loading port in relation to the shredding mechanism is such that the thus received material will drop under the influence of gravity onto and be shredded by the shredding mechanism. The shredded material exits through a discharge port underlying the shredding mechanism.”

U.S. Pat. No. 5,794,864 to Hammett, et al. describes a “portable apparatus for shredding yard and garden waste. Particularly shaped blades are used for better shredding and mulching performance.”

Finally, U.S. Pat. No. 7,654,480 to Baer, et al. discloses a “mulcher [that] has a base unit and a shredding blade in a removable assembly. Two different embodiments are disclosed. In both embodiments, shredded material is removed from air exiting the shredding blade before it reaches an exhaust port. In one embodiment, the material is removed by a filter. In the other embodiment, walls are arranged so that debris must double back against high-speed airflow leaving the shredding blade before exiting the unit. The shredding blade can be mounted in front of and on the same shaft as an air impeller, with the back surface of the shredding blade being supported by the impeller. In another embodiment, the air impeller and the shredding blade are carried in assemblies that are separable from each other and are each separately attachable is to a base unit. A detachable power module and a detachable blower are also shown. The power module has a safety switch that disables the power module when it is removed. A power receptacle is shown with a switch that alternately switches power to either the shredder motor or to the power receptacle, but not to both simultaneously.”

The inventions disclosed and taught herein are directed to an improved wet/dry vacuum appliance leaf mulching assembly, and methods of use thereof.

### BRIEF SUMMARY OF THE INVENTION

The objects described above and other advantages and features of the invention are incorporated in the application as set forth herein, and the associated drawings, related to systems for association with a wet/dry vacuum appliance for use in cleaning up and mulching leaves and other yard waste debris, are described.

In accordance with a first embodiment of the present disclosure, the invention comprises an attachment for a utility vacuum appliance, having a housing with an inlet and an outlet, the inlet configured to mate with a hose and the outlet configured to mate with a port of a vacuum appliance; and a mulching assembly within the housing and operable to mulch yard debris as the debris passes from the inlet to the outlet.

In another embodiment the invention comprises an attachment for a utility vacuum appliance, having a housing with an inlet and an outlet, the inlet configured to mate with a port of a vacuum appliance; and a mulching assembly within the housing and operable to mulch yard debris as the debris passes from the inlet to the outlet.

In another embodiment, the invention comprises a method of improving a utility vacuum appliance, by connecting an outlet of a mulching unit to a port of a vacuum appliance; and, connecting a hose to an inlet of the mulching unit.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a particular embodiment of a vacuum appliance utilizing certain aspects of the present inventions;

FIG. 2 illustrates another particular embodiment of a vacuum appliance shown with a mulching attachment utilizing certain aspects of the present inventions;

FIG. 3 illustrates a particular embodiment of a vacuum appliance with a hose connected thereto, utilizing certain aspects of the present inventions;

FIG. 4 illustrates a particular embodiment of the vacuum appliance of FIG. 3, with a mulching attachment connected between the vacuum appliance and the hose;

FIG. 5 illustrates a close-up sectional view of a mulching attachment utilizing certain aspects of the present inventions; and

FIG. 6 illustrates a close-up sectional view of the mulching attachment utilizing certain aspects of the present inventions shown inside a vacuum appliance.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or is scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment.

Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created, in one embodiment, an attachment for a utility vacuum appliance, having a housing with an inlet and an outlet, the inlet configured to mate with a hose and the outlet configured to mate with a port of a vacuum appliance; and a mulching assembly within the housing and operable to mulch yard debris as the debris passes from the inlet to the outlet. In another embodiment, the attachment comprises a housing with an inlet and an outlet, the inlet configured to mate with a port of a vacuum appliance; and a mulching assembly within the housing and operable to mulch yard debris as the debris passes from the inlet to the outlet.

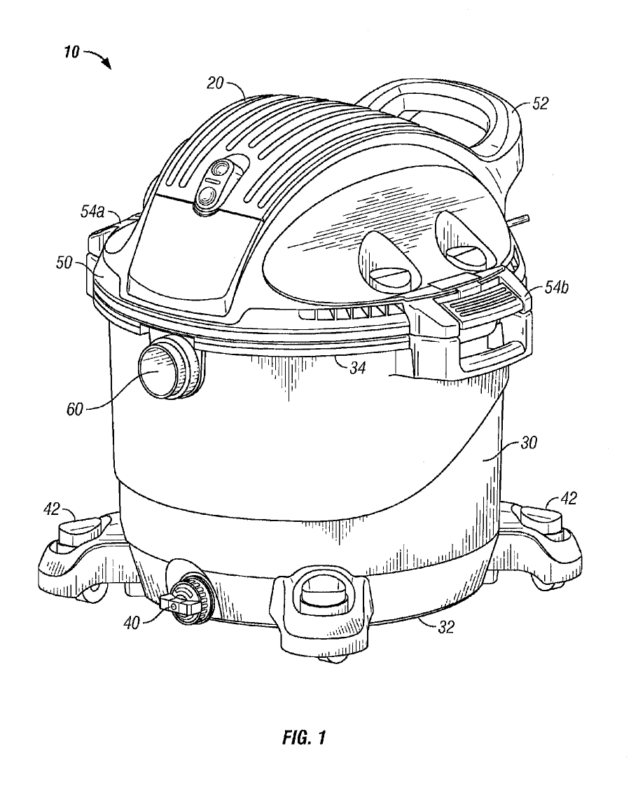

Turning now to the figures, FIG. 1 illustrates a schematic, perspective view of an exemplary vacuum appliance system 10 for use with the present disclosure. The vacuum appliance system 10 may include components similar to those shown in one or more of U.S. Patent Application Publication No. 2009/0265882, U.S. Patent Application Publication No. 2009/0123293, U.S. Design Pat. No. D551,681, and/or U.S. Design Pat. No. D528,718, each of which is incorporated herein by specific reference in their entirety.

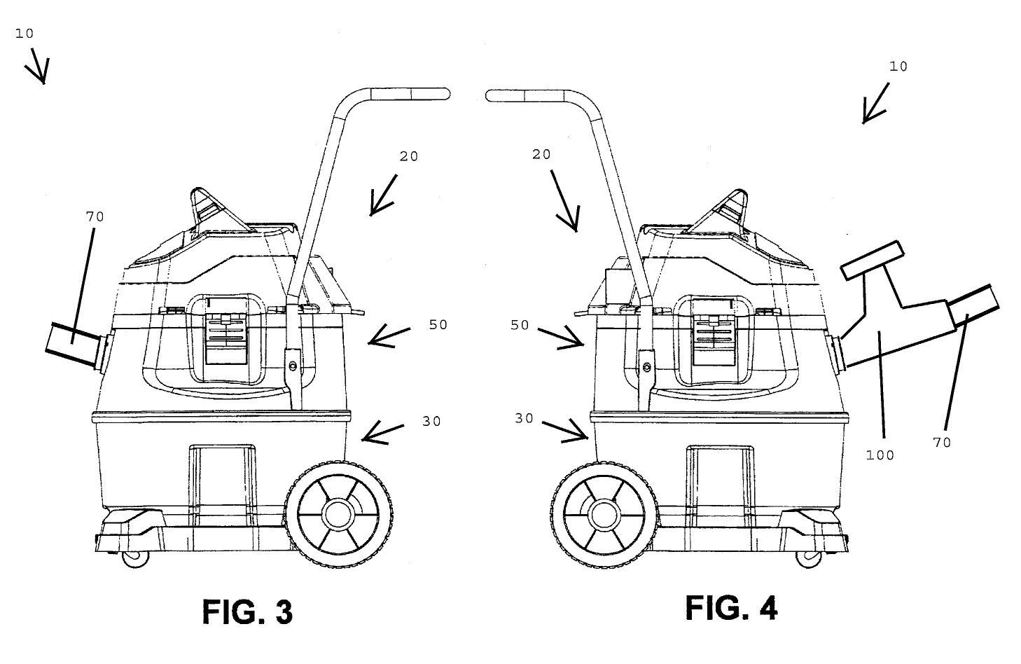

In one exemplary embodiment, the system 10 shown includes a wet/dry vacuum appliance 20 comprising a collection drum or chamber 30 having a closed bottom end 32 and at least one side wall extending upwardly and generally perpendicular to bottom 32, casters 42 mountable on the bottom end 32 of the drum 30, and a lid 50 removably attached to the open, top end 34 of the collection drum 30, the lid 50 containing a powerhead. The lid 50 is removably attached (e.g., by way of lid handle 52, via a hinge mechanism or the like, or via completely detaching and lifting the lid 50 off from the top end 34 of drum 30 by releasing latches 54) to the collection drum 30 so that the lid can be readily removed so as to empty debris or liquids contained within the drum or to change or clean a filter assembly (not shown) that is typically mounted in association with the underside of a motor housing, powerhead, or lid of the vacuum appliance. As with most wet/dry vacuum cleaners, a motor (not shown) is generally coupled to the mounting assembly on the inside portion of lid 50 of the vacuum cleaner 20, which is operable to create the vacuum inside the collection drum 30 so as to draw solid debris, liquid, or both into the collection drum 30 through an inlet port 60 by way of a vacuum hose 70, as best shown in FIG. 3. Inlet port 60 may be located in the upper side wall of the collection drum 30, or in the lid 50, as appropriate for the design and style of vacuum appliance. The collection drum 30 may also optionally include a drain 40 positioned proximate bottom end 32 so that liquid within the drum can be emptied (e.g., via a pump such as that described in U.S. Design Pat. No. D551,681) and removed without having to undo and remove the lid 50. Vacuum appliances such as the system 10 generally include a filter assembly, as well as a mounting assembly and/or a filter cage (not shown), such as described in U.S. Pat. No. 8,206,482, the relevant contents of which are incorporated herein by reference, and which is typically coupled to or integrally formed with the underside of the lid 50 or motor housing, extending downwardly into collection drum 30.

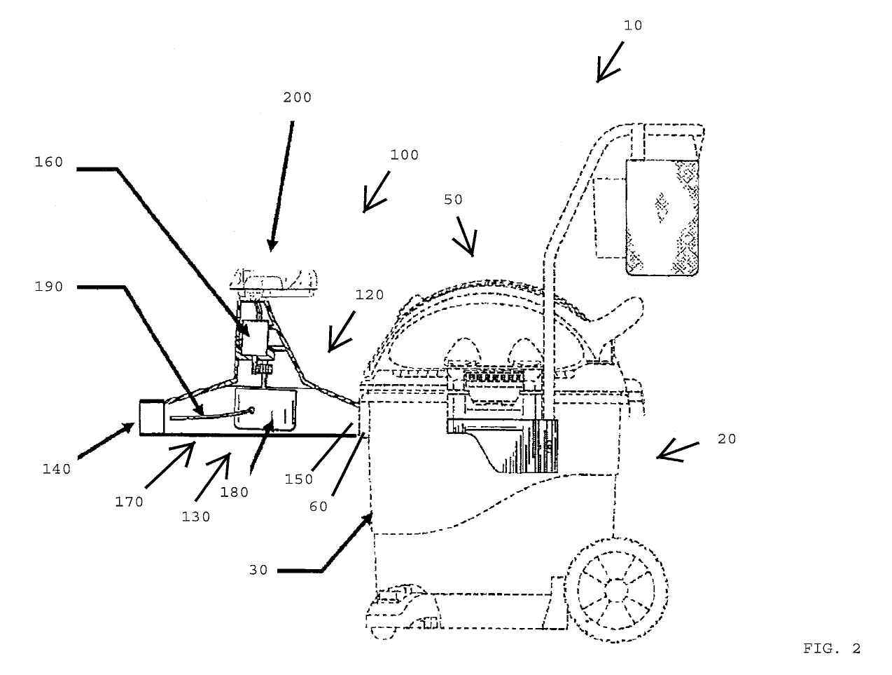

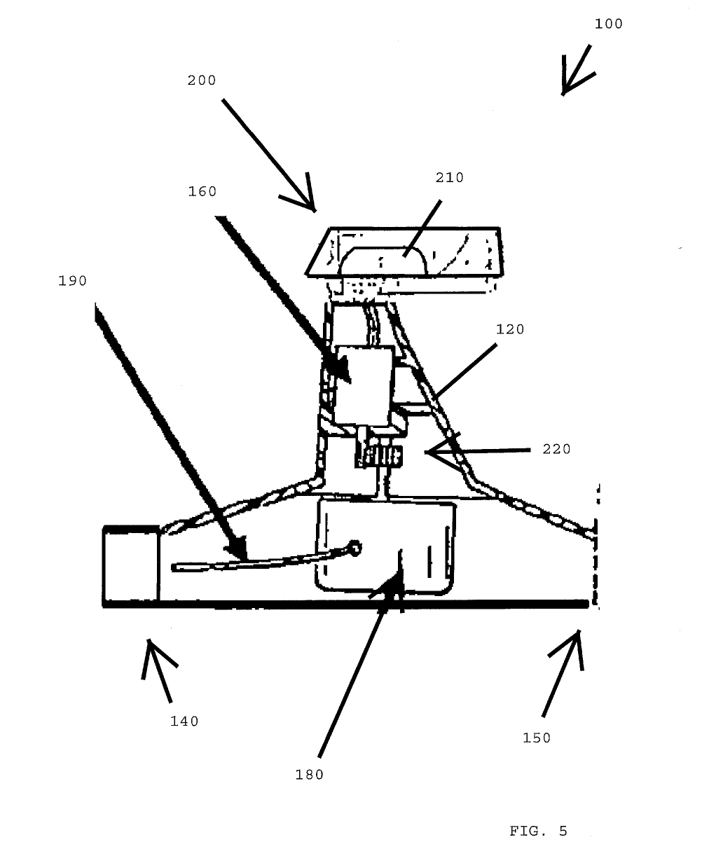

As illustrated in FIG. 2, the system 10 in accordance with the present disclosure also includes a mulching unit 100, which may take the form of an external attachment to the vacuum appliance 20 as shown, or may be an integral part of the vacuum. The mulching unit 100 may include an external, mulching housing 120 containing a mulching assembly 130. The housing 120 may include an inlet 140 to receive a vacuum hose 70, as shown in FIG. 4, and a 180-degree opposite spaced outlet 150 that is sized to mate with the vacuum inlet port 60 of the vacuum appliance 20. The port 60 that would likely otherwise be configured to receive the hose 70 is preferably configured to also support the external mulching unit attachment 100.

The mulching assembly 130 may include a motor 160 and an appropriate means for shredding and breaking up yard waste, such as string trimmer 170 (or the equivalent cutting structure) which may include a spool 180 containing a quantity of flexible trimmer line 190 capable of automatically feeding outward so as to maintain a length an appropriate distance between the outer edge of the spool 180 and the interior chamber walls 132 of the mulching assembly so as to prevent debris from is wedging between the cutting structure(s) and the interior side walls of the assembly 130. Alternatively, the cutting structure may include one, two, or more (a plurality of) rigid or flexible/flailing blades (not shown) of the same or different lengths that are fixed or not fixed coupled to the shaft 170, separate from or in addition to a string trimmer assembly, or one or more lengths of the trimmer line 190. Such cutting assemblies pivot or rotate about an impeller shaft 170 or similar drive shaft capable of converting the energy of the motor 160 to rotational motion, such as a shaft that is substantially parallel to an axis of rotation of the mulching motor 160. In operation, the mulching assembly 130 is externally attached to the vacuum appliance 20 by association of the outlet 150 with the vacuum inlet 60, such as by a friction fit (e.g., the external diameter of the outlet 150 is less than the internal diameter of the vacuum appliance, allowing for a friction-type attachment), or by way of a locking assembly on the end of outlet 150, associated with inlet 60, or both. Thereafter, a vacuum hose 70 or similar elongate vacuum tube having first and second opposite ends (not shown) is attached to the inlet 140, such as by a friction fit or a locking association of the first end to the inlet 140. Thereafter, the second end of the vacuum hose 70, having an opening, is placed in close proximity to the ground or other surface and the unit 130 and vacuum appliance 20 are both powered on. Yard debris on the surface is entrained in a flow of air travelling upward through the vacuum tube, through the mulching unit, and towards the impeller within the powerhead assembly of the vacuum appliance. As yard debris, such as leaves or grass clippings, passes from the inlet 140 to the outlet 150, due to the suction created by the vacuum appliance 20, the mulching assembly 130 cuts, crushes, grinds, shreds, or otherwise mulches the debris when the debris encounters the cutting structure within the mulching assembly 130. The shredded debris is then carried by the flow of air from the vacuum appliance out through the outlet 150 and into the collection drum 30, where it is collected. The shredded debris may be collected directly in the collection drum 30, or alternatively, it may be collected in a vacuum bag (now shown) sized to fit within the interior of the collection drum and including an opening sized to mate with the section of inlet 60 extending into the interior of the collection drum. The shredded debris has a much reduced size and mass after passing through the mulching assembly, and in this manner, the volume of the drum 30 may be better utilized.

In cases where the mulching assembly 130 takes the form of an external attachment, the mulching assembly 130 may be used with virtually any wet/dry vacuum, without requiring modifications to the vacuum appliance 20 or the hose 70. More specifically, the port 60 of commonly available vacuum appliances, such as vacuum appliance 20, is designed to mate with, receive, or otherwise accept the hose 70. Thus, the outlet 150 of the mulching unit 100 may be configured to mimic the hose 70, and thereby be received in, or otherwise mate with, the port 60 of the vacuum appliance 20. Furthermore, the inlet of the mulching unit 100 may be configured to mimic the port 60, and thereby receive, or otherwise mate with, the hose 70.

Thus, one can improve the utility and application of a vacuum appliance 20, especially when the vacuum is used to pick up leaves and other yard debris, by simply removing the hose 70 from the port 60, connecting the outlet 150 to the port 60, and connecting the hose 70 to the inlet 140 of the mulching unit 100. FIG. 3 shows the vacuum appliance 20 with the hose 70 mated to the port 60. FIG. 4 shows the vacuum appliance 20 with the mulching unit 100 connected between the hose 70 and the port 60.

The motor 160, or the mulching assembly 130 in general, may be powered by the same power source that drives the powerhead of the vacuum appliance 20. Alternatively, the motor 160 may be powered by a separate power source, such as a battery or a separate cord or power connection. In still other embodiments, the mulching unit 100 may include a special cord that plugs into a receptacle on the vacuum appliance 20, or between a cord and receptacle, or plug, of the vacuum appliance 20. Alternatively, the mulching assembly 130 may be powered by a flexible drive shaft connected to another motor, such as that of the powerhead of the vacuum appliance 20. In still other embodiments, the mulching assembly 130 may be powered by a vacuum drawn by the vacuum appliance 20. To accommodate connection to one or more of these power sources, the mulching unit 100 may include a head 200.

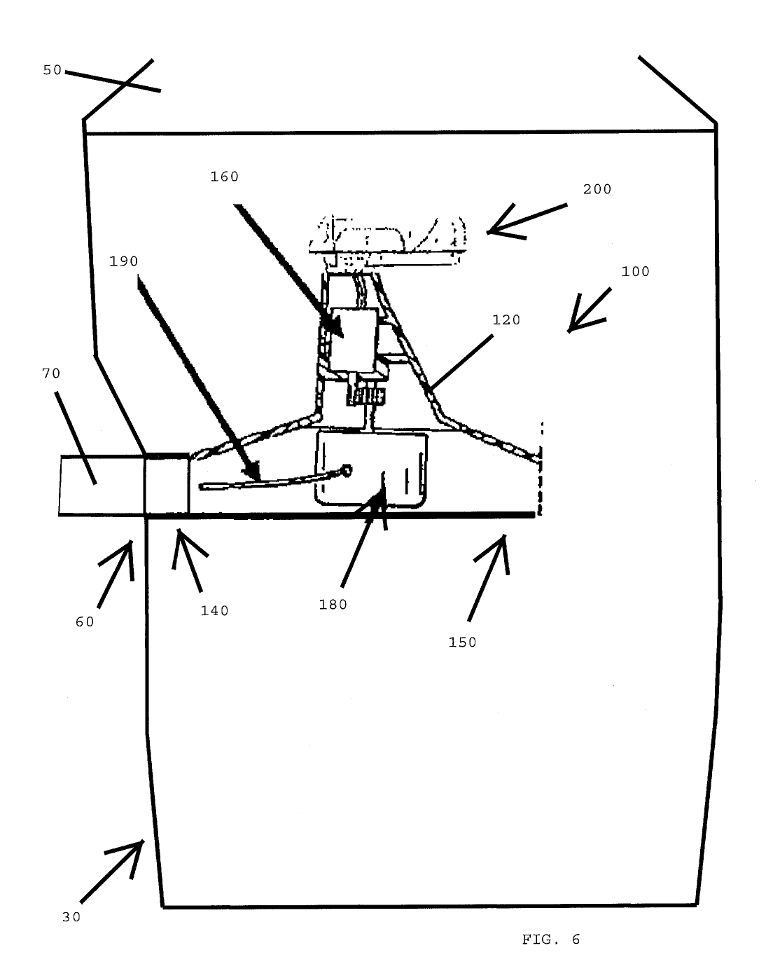

More specifically, as shown in FIG. 5, the head 200 may incorporate a battery 210 which supplies power to the motor 160 of the mulching assembly 130. Thus, the mulching unit 100 may be operated completely independently of the vacuum appliance 20. To provide further independence, the line 190 may take the form of, or be replaced by, blades to mulch debris and move the debris through the hose 70, the housing 120, and into the drum 30.

As discussed above, the mulching assembly 130 may be driven by a flexible drive shaft. As such, the mulching assembly 130 may be driven by the powerhead, or fan motor, of the vacuum appliance 20, this may be particularly useful where the mulching unit 100 is fitted within the interior region of vacuum appliance 20, as shown in FIG. 6. In this case, the mulching assembly 130 may further include a gear drive system 220. In the case shown, the spool 180 is geared down from the motor 60, i.e. the spool 180 may rotate slower than the motor 60 or flexible drive shaft. In other embodiments, the spool 180 may be geared up, i.e. rotate faster than, the motor 160, flexible drive shaft, etc.

Other and further embodiments utilizing one or more aspects of the inventions described above can be devised without departing from the spirit of Applicant's invention. For example, the mulching unit 100 may be incorporated within the lid 50 or drum 30. More specifically, in one embodiment, the mulching unit may fit within the drum 30 with the port 60 of the vacuum appliance 20 mating with both the inlet 140 and the hose 70, as shown in FIG. 6. Further, the various methods and embodiments of the present invention can be included in combination with each other to produce variations of the disclosed methods and embodiments. Discussion of singular elements can include plural elements and vice-versa.

Other and further embodiments utilizing one or more aspects of the inventions described above can be devised without departing from the spirit of Applicant's invention. For example, and without limitation, the mulching unit described herein may be removably or permanently integrated into the powerhead assembly of the vacuum appliance. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. An attachment for a utility vacuum appliance, the attachment comprising:
a housing with an inlet and an outlet, the inlet configured to mate with a hose and the outlet configured to mate with an inlet port of a vacuum appliance; and
a mulching assembly within the housing and operable to mulch yard debris as the debris passes from the inlet to the outlet.

2. The attachment of claim 1, wherein the outlet is configured to mimic the hose, such that the port to which the outlet mates is configured to mate with the hose.

3. The attachment of claim 1, wherein the inlet is configured to mimic the port, such that the hose to which the inlet mates is configured to mate with the port.

4. The attachment of claim 1, wherein the mulching assembly includes a motor.

5. The attachment of claim 4, wherein the motor is driven by a power source separate from the vacuum appliance's power source.

6. The attachment of claim 4, wherein the motor is driven by a power source of the vacuum appliance.

7. The attachment of claim 4, wherein the motor is driven by a power source that also powers the vacuum appliance.

8. The attachment of claim 1, wherein the mulching assembly is driven by the vacuum appliance.

9. The attachment of claim 1, wherein the mulching assembly is operable to draw the debris through the hose, the housing, and into the vacuum appliance.

10. An attachment for a utility vacuum appliance, the attachment comprising:
a housing with an inlet and an outlet, the inlet configured to mate with a port of a vacuum appliance; and
a mulching assembly within the housing and operable to mulch yard debris as the debris passes from the inlet to the outlet.

11. The attachment of claim 10, wherein the attachment resides within a drum of the vacuum appliance.

12. The attachment of claim 10, wherein the port mates with both the inlet and a hose.

13. The attachment of claim 10, wherein the mulching assembly includes a motor.

14. The attachment of claim 13, wherein the motor is driven by a power source separate from the vacuum appliance's power source.

15. The attachment of claim 13, wherein the motor is driven by a power source of the vacuum appliance.

16. The attachment of claim 13, wherein the motor is driven by a power source that also powers the vacuum appliance.

17. The attachment of claim 10, wherein the mulching assembly is driven by the vacuum appliance.

18. The attachment of claim 10, wherein the mulching assembly is operable to draw the debris through the hose, the housing, and into the vacuum appliance.

19. A method of improving a utility vacuum appliance, the method comprising the steps of:
connecting an outlet of a mulching unit to a port of a vacuum appliance; and
connecting a hose to an inlet of the mulching unit.

20. The method of claim 19, further comprising the step of disconnecting the hose from the port before connecting the mulching unit to the port.
